(19) United States
(12) Patent Application Publication
(10) Pub. No.: US 2026/0350777 A1
(43) Pub. Date: Nov. 5, 2026

(54) AUTOMATIC ZONE GENERATION FOR OVERLAY METROLOGY

(71) Applicant: Applied Materials Israel Ltd., Rehovot (IL)

(72) Inventors: Ifat NEUBERGER, Ness Ziona (IL); Mira HERMONI, Jerusalem (IL); Tal BEN-SHLOMO, Givatayim (IL); Dror ALUMOT, Tel-Aviv (IL)

(21) Appl. No.: 19/199,325

(22) Filed: May 5, 2025

(51) Int. Cl. G06T 7/00; G06T 7/68

(52) U.S. Cl. CPC G06T 7/0006; G06T 7/68; G06T 2207/30148

(57) ABSTRACT

There is provided a system and method of automatic zone generation for overlay metrology on a semiconductor specimen. The method comprises obtaining design data of a specimen having at least a first layer and a second layer and acquiring corresponding image data; providing a plurality of zone options for each layer by (i) identifying candidate zone options from the design data, and (ii) executing a zone optimization process using the image data to determine a zone option defined by optimized values of one or more zone parameters that yields optimal measurement performance; computing an overlay measurement between the first and second layers for different combinations of the zone options; and selecting a combination that provides optimal overall overlay performance.

### TECHNICAL FIELD

The presently disclosed subject matter relates, in general, to the field of examination of a semiconductor specimen, and more specifically, to overlay metrology for semiconductor specimen examination.

### BACKGROUND

Current demands for high density and performance associated with ultra large-scale integration of fabricated devices require nanometer-scale features, increased transistor and circuit speeds, and improved reliability. With increasing miniaturization and complexity of semiconductor designs, the dimensions of device features, often referred to as critical dimensions, are continuously decreasing. Such demands require formation of device features with high precision and uniformity, which, in turn, necessitates careful monitoring and accurate control throughout the fabrication process, including automated examination of the devices while they are still in the form of semiconductor wafers.

Semiconductor devices are fabricated through a series of complex processes, including photolithography, etching, deposition, planarization, and implantation, etc., to define precise patterns and structures on semiconductor wafers. To ensure the quality and reliability of the final semiconductor devices, examination steps may be conducted repeatedly throughout the manufacturing process, for example, following specific processing steps, after forming particular layers, or at other designated manufacturing stages.

With each successive processing step, slight misalignments between layers can occur due to variations in the fabrication process. Overlay metrology can be employed to quantify these misalignments, providing critical feedback that enables adjustments in the manufacturing process to maintain alignment accuracy. This feedback may be vital for ensuring device performance, as even minor overlay errors can lead to degraded electrical performance or reduced yield in the final product.

Automated inspection techniques play a significant role in this context. Imaging technologies, such as optical microscopy and scanning electron microscopy (SEM), can be used to capture high-resolution images of wafers. These images are then analyzed using computational methods to detect defects, assess alignment accuracy, and monitor process variations. Moreover, abstract design data, such as computer-aided design (CAD) data, defines the intended geometrical patterns of the integrated circuits. CAD data not only guides the fabrication process but also facilitates inspection by providing a reference against which actual wafer features can be compared.

Overlay metrology may be addressed using various approaches, such as image-based segmentation, or overlay targets, etc. In some cases, overlay metrology may leverage both the real-world image information captured by imaging systems and the abstract design information from CAD representations, to allow for a more comprehensive assessment of the wafer's layer-to-layer alignment.

### SUMMARY

In accordance with certain aspects of the presently disclosed subject matter, there is provided a computerized system of automatic zone generation for overlay metrology on a semiconductor specimen, the system comprising a processing circuitry configured to: obtain design data and image data of the semiconductor specimen comprising at least a first layer and a second layer; provide a plurality of first zone options for the first layer and a plurality of second zone options for the second layer, comprising, for each of the first layer and the second layer: i) identify, based on the design data, a plurality of candidate zone options each representing an initial measurement region characterized by one or more initial values of one or more zone parameters; and ii) execute a zone optimization process for each candidate zone option using the image data, to determine a zone option characterized by one or more optimized values for the one or more zone parameters, the zone option representing an optimal configuration that, when applied to the image data, yields optimal measurement performance for the candidate zone option; compute an overlay measurement between the first layer and the second layer for different combinations of the first zone options and the second zone options; and select a combination of a first zone option and a second zone option which provides optimal overall performance for the overlay measurement.

In addition to the above features, the system according to this aspect of the presently disclosed subject matter can comprise one or more of features (i) to (x) listed below, in any desired combination or permutation which is technically possible:
(i). The processing circuitry can be configured to identify the plurality of candidate zone options for each designated layer of the first layer and the second layer by separating one or more target features on the designated layer from one or more remaining features in the designated layer and/or in one or more remaining layers of the design data; and defining the plurality of candidate zone options to enclose at least part of the one or more target features, such that each candidate zone option comprises one or more symmetric candidate zones, and does not overlap interfering features from the designated layer and/or the one or more remaining layers.
(ii). The one or more zone parameters can comprise one or more of a zone shift parameter, a zone pitch parameter, and a zone size parameter.
(iii). The zone optimization process can comprise, for each candidate zone option, varying values of the one or more zone parameters to generate a permutation array of modified zone options; evaluating the modified zone options in the permutation array using the image data to determine measurement performance; and selecting, from the permutation array, a modified zone option that yields optimal measurement performance to be the optimal configuration of the candidate zone option.
(iv). The evaluating of the modified zone options comprises, for each modified zone option in the permutation array, calculating one or more measurement metrics based on the image data to which the modified zone option is applied; calculating a robustness score for each of the one or more measurement metrics; and selecting the modified zone option from the permutation array to be the optimal configuration, based on at least some of the one or more measurement metrics and the robustness score thereof for each modified zone option.
(v). The one or more measurement metrics comprise at least one of a symmetry center metric or an image symmetry metric.
(vi). Each candidate zone option comprises at least two pairs of symmetric candidate zones. The symmetry center metric and image symmetry metric, and the robustness score thereof, are calculated for each pair of the two pairs of symmetric candidate zones. The optimization process further comprises calculating a symmetry center difference metric by comparing the symmetry center metrics of the two pairs of symmetric candidate zones. The optimal configuration is selected further based on the symmetry center difference metric.
(vii). The robustness score is calculated based on a standard deviation of each measurement metric over a set of neighboring modified zone options of a given modified zone option within the permutation array.
(viii). The robustness score quantifies sensitivity of the one or more measurement metrics of a given modified zone option to variations across a set of neighboring modified zone options.
(ix). The selected combination is used to measure overlay for one or more runtime specimens sharing the same design data as the semiconductor specimen.
(x). The optimal overall performance for the overlay measurement is in terms of precision and correlation.

In accordance with other aspects of the presently disclosed subject matter, there is provided a computerized method of automatic zone generation for overlay metrology on a semiconductor specimen, the method comprising obtaining design data of the semiconductor specimen comprising at least a first layer and a second layer, and acquiring image data of the specimen; providing a plurality of first zone options for the first layer and a plurality of second zone options for the second layer, comprising, for each of the first layer and the second layer: i) identifying, based on the design data, a plurality of candidate zone options each representing an initial measurement region characterized by one or more initial values of one or more zone parameters; and ii) executing a zone optimization process for each candidate zone option using the image data, to determine a zone option characterized by one or more optimized values for the one or more zone parameters, the zone option representing an optimal configuration that, when applied to the image data, yields optimal measurement performance for the candidate zone option; computing an overlay measurement between the first layer and the second layer for different combinations of the first zone options and the second zone options; and selecting a combination of a first zone option and a second zone option which provides optimal overall performance for the overlay measurement.

This aspect of the disclosed subject matter can comprise one or more of features (i) to (x) listed above with respect to the system, mutatis mutandis, in any desired combination or permutation which is technically possible.

In accordance with other aspects of the presently disclosed subject matter, there is provided a non-transitory computer-readable medium comprising instructions that, when executed by a computer, cause the computer to perform a method of automatic zone generation for overlay metrology on a semiconductor specimen, the method comprising: obtaining design data of the semiconductor specimen comprising at least a first layer and a second layer, and acquiring image data of the specimen; providing a plurality of first zone options for the first layer and a plurality of second zone options for the second layer, comprising, for each of the first layer and the second layer: i) identifying, based on the design data, a plurality of candidate zone options each representing an initial measurement region characterized by one or more initial values of one or more zone parameters; and ii) executing a zone optimization process for each candidate zone option using the image data, to determine a zone option characterized by one or more optimized values for the one or more zone parameters, the zone option representing an optimal configuration that, when applied to the image data, yields optimal measurement performance for the candidate zone option; computing an overlay measurement between the first layer and the second layer for different combinations of the first zone options and the second zone options; and selecting a combination of a first zone option and a second zone option which provides optimal overall performance for the overlay measurement.

This aspect of the disclosed subject matter can comprise one or more of features (i) to (x) listed above, mutatis mutandis, in any desired combination or permutation which is technically possible.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a generalized block diagram of an examination system in accordance with certain embodiments of the presently disclosed subject matter.

FIG. 2 illustrates a generalized flowchart of automatic zone generation for overlay metrology in accordance with certain embodiments of the presently disclosed subject matter.

FIG. 3 illustrates a generalized flowchart of a zone optimization process in accordance with certain embodiments of the presently disclosed subject matter.

FIG. 4 illustrates a generalized flowchart of an evaluation process of the modified zone options in accordance with certain embodiments of the presently disclosed subject matter.

FIG. 5 illustrates a generalized flowchart of an identification process for candidate zone options in accordance with certain embodiments of the presently disclosed subject matter.

FIG. 6 and FIG. 7 illustrate an example of target feature separation on different layers based on an exemplified specimen in accordance with certain embodiments of the presently disclosed subject matter.

FIG. 8 illustrates examples of candidate zone options separately defined for the two main layers in accordance with certain embodiments of the presently disclosed subject matter.

FIG. 9 illustrates examples of zone parameters and how they can be varied to create a permutation array of zone configurations in accordance with certain embodiments of the presently disclosed subject matter.

FIG. 10 illustrates further details of the 3D permutation array of zone configurations in accordance with certain embodiments of the presently disclosed subject matter.

FIG. 11 illustrates an example of calculating the symmetry center metric in accordance with certain embodiments of the presently disclosed subject matter.

FIG. 12 illustrates an example of an NRMS metric in accordance with certain embodiments of the presently disclosed subject matter.

FIG. 13 shows a schematic illustration of how the robustness score is computed for a given cell in the 3D array in accordance with certain embodiments of the presently disclosed subject matter.

FIG. 14 illustrates an example of robustness analysis for varying zone size in accordance with certain embodiments of the presently disclosed subject matter.

FIG. 15 illustrates a schematic flow of automatic zone generation for two pairs of symmetric zones in accordance with certain embodiments of the presently disclosed subject matter.

FIG. 16 illustrates how the best configuration is assessed in accordance with certain embodiments of the presently disclosed subject matter.

FIG. 17 illustrates the plurality of optimized lower zone options and optimized upper zone options obtained for the candidate zone options of the lower layer and the upper layer of the specimen in accordance with certain embodiments of the presently disclosed subject matter.

### DETAILED DESCRIPTION OF EMBODIMENTS

Overlay metrology aims to accurately measure the relative alignment between successive layers of a semiconductor specimen. This overlay error is crucial to process control and monitoring, since even small deviations can negatively impact the performance and yield of semiconductor devices. As semiconductor designs become more complex and feature sizes decrease, overlay measurement faces several significant challenges.

One approach for overlay metrology involves determining the center of symmetry (COS) of features on each semiconductor layer. In this approach, each layer's relevant structure (e.g., a target pattern) is analyzed to find the point (e.g., COS) around which its signal appears symmetrical. By measuring and comparing the COS of a first-layer feature with the COS of a second-layer feature, the system can quantify any misalignment (overlay error) between the layers.

In such approaches, the key to obtaining a reliable overlay measurement lies in the careful selection of measurement regions/zones on each layer. These zones, also referred to as regions of interest (ROIs), are defined specifically to enclose the critical portions of the structures formed on each layer, on which the COS is to be calculated. However, defining the right zones can be challenging due to a variety of factors, including process variations, image artifacts, and noises, etc. If a zone is not well-selected, the measurement signals used for COS determination may be contaminated by extraneous features, partial structures, or overlapping signals from non-target layers. Such contamination can distort the symmetry analysis, leading to inaccurate overlay measurements. Moreover, in some instances, supposedly symmetric zones might not actually exhibit symmetry in the captured image, owing to real-world variations in fabrication or imaging conditions. Consequently, careful zone selection is vital for isolating the relevant signal and ensuring that the COS calculation accurately reflects the true overlay between the layers.

Traditionally, overlay metrology mainly relies on manual selection and drawing of measurement zones by experienced engineers. Manual methods are inherently subjective and depend heavily on the expertise of the operator. Even slight variations in how different operators delineate these zones can lead to inconsistent measurements and, ultimately, reduced process control. Moreover, manual drawing of measurement zones is both time-consuming and prone to error, increasing the likelihood of misaligned measurement regions that do not accurately reflect the intended design features.

Indeed, conventional methods do not provide a systematic approach to optimize these impacting factors. The absence of an automated process to refine zone selections means that the final measurement zones may not be the best possible representations for overlay evaluation, leading to potential degradation in overlay precision and increased measurement uncertainty. Consequently, these limitations underscore the need for an automated system that can robustly generate and refine measurement zones.

Accordingly, certain embodiments of the presently disclosed subject matter propose a system and method for automatic zone generation for overlay metrology, which does not have one or more of the disadvantages described above. In certain embodiments of the present disclosure, the proposed approach integrates design data with image data to automatically identify candidate measurement zones, then optimizes the configurations of these zones through an optimization process, e.g., by assessing measurement metrics, to select the optimal measurement zones for each layer. This approach allows to minimize user dependency, improve measurement performance such as precision, and effectively compensate for process variations and enhance robustness, as will be detailed below.

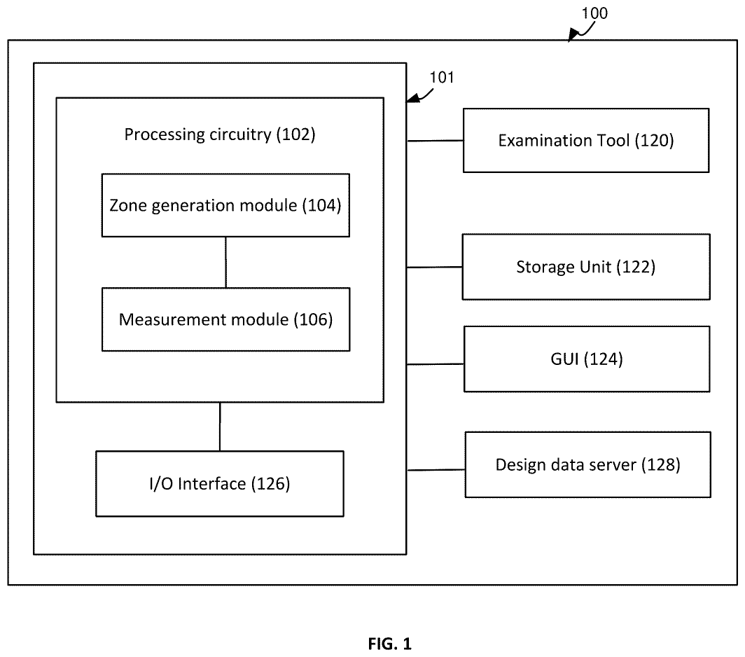

Bearing this in mind, attention is drawn to FIG. 1 illustrating a functional block diagram of an examination system in accordance with certain embodiments of the presently disclosed subject matter.

The examination system 100 illustrated in FIG. 1 can be used for examination of a semiconductor specimen (e.g., a wafer, a die, or parts thereof) as part of the specimen fabrication process. As described above, the examination referred to herein can be construed to cover any kind of operations related to metrology, defect inspection, defect review, defect classification, nuisance filtration, and/or segmentation, etc., with respect to the specimen. System 100 comprises one or more examination tools 120 configured to scan a specimen and capture images thereof to be further processed for various examination applications.

The term “examination tool(s)” used herein should be expansively construed to cover any tools that can be used in examination-related processes, including, by way of non-limiting example, scanning (in a single or in multiple scans), imaging, sampling, reviewing, measuring, classifying, and/or other processes provided with regard to the specimen or parts thereof. Without limiting the scope of the disclosure in any way, it should also be noted that the examination tools can be implemented as inspection machines of various types, such as optical inspection machines, electron beam inspection machines (e.g., a Scanning Electron Microscope (SEM), an Atomic Force Microscopy (AFM), or a Transmission Electron Microscope (TEM), etc.), and so on.

In some embodiments of the present disclosure, at least one of the examination tools 120 has metrology capabilities and can be configured to capture images and perform metrology operations on the captured images. Such an examination tool is also referred to as a metrology tool.

One example of a metrology tool used within the examination system is a Critical Dimension Scanning Electron Microscope (CD-SEM). CD-SEM is a specialized tool designed to capture high-resolution images of semiconductor structures and perform metrology operations on those structures for different metrology applications. By way of example, the CD-SEM can be used to obtain critical dimension (CD) measurements with respect to certain structural features on the specimen to determine if they meet the design specifications. In another example, the CD-SEM's metrology capabilities can be leveraged to measure critical metrics between layers, such as overlay, to assess whether the alignment between layers remains within acceptable limits.

In some embodiments, optionally, in addition to or in lieu of the metrology tool, the one or more examination tools 120 can include one or more inspection tools and/or one or more review tools. In some cases, an inspection tool can be configured to scan a specimen (e.g., an entire wafer, an entire die, or portions thereof) to capture inspection images (typically, at a relatively high speed and/or low resolution) for detection of potential defects (i.e., defect candidates). During inspection, the wafer can move at a step size relative to the detector of the inspection tool (or the wafer and the tool can move in opposite directions relative to each other) during the exposure, and the wafer can be scanned step-by-step along swaths of the wafer by the inspection tool, where the inspection tool images a part/portion (within a swath) of the specimen at a time. By way of example, the inspection tool can be an optical inspection tool. In optical inspection, an array of parallel laser beams can scan the surface of a wafer along the swaths. The swaths are laid down in parallel rows/columns contiguous to one another, to build up, swath-at-a-time, an image of the surface of the wafer. For instance, the tool can scan a wafer along a swath from up to down, then switch to the next swath and scan it from down to up, and so on and so forth, until the entire wafer is scanned and inspection images of the wafer are collected.

In some cases, a review tool can be configured to capture review images of at least some of the defect candidates detected by inspection tools for ascertaining whether a defect candidate is indeed a defect of interest (DOI). Such a review tool is usually configured to inspect fragments of a specimen, one at a time (typically, at a relatively low speed and/or high resolution). By way of example, the review tool can be an electron beam tool, such as, e.g., a scanning electron microscope (SEM), etc.

The various examination tools can be different tools located at the same or at different locations, or integrated as a single tool operated in different modes. In some cases, the same examination tool can provide low-resolution image data and high-resolution image data. The resulting image data (low-resolution image data and/or high-resolution image data) can be transmitted—directly or via one or more intermediate systems—to system 101. The present disclosure is not limited to any specific type of examination tools and/or the resolution of image data resulting from the examination tools.

According to certain embodiments of the presently disclosed subject matter, the examination system 100 comprises a computer-based system 101 operatively connected to the examination tool 120, and capable of automatic zone generation for overlay metrology. System 101 is thus also referred to as a zone generation or creation system.

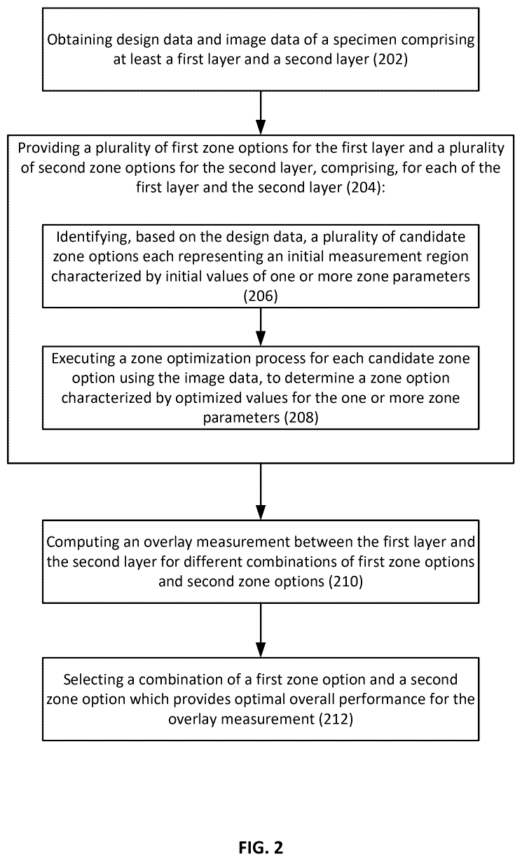

System 101 includes a processing circuitry 102 operatively connected to a hardware-based I/O interface 126 and configured to provide processing necessary for operating the system, as further detailed with reference to FIGS. 2-5. The processing circuitry 102 can comprise one or more processors (not shown separately) and one or more memories (not shown separately). The one or more processors of the processing circuitry 102 can be configured to, either separately or in any appropriate combination, execute several functional modules in accordance with computer-readable instructions implemented on a non-transitory computer-readable memory comprised in the processing circuitry. Such functional modules are referred to hereinafter as comprised in the processing circuitry.

According to certain embodiments, one or more functional modules comprised in the processing circuitry 102 of system 101 can include a zone generation module 104 and a measurement module 106. Specifically, the processing circuitry 102 can be configured to obtain, via an I/O interface 126, design data of a semiconductor specimen which comprises at least a first layer and a second layer. The processing circuitry 102 can be configured to further obtain image data of the specimen, such as, e.g., acquired by the examination tool 120.

The zone generation module 104 can be configured to provide a plurality of first zone options for the first layer and a plurality of second zone options for the second layer. Specifically, for each of the first layer and the second layer, the zone generation module 104 can be configured to identify, based on the design data, a plurality of candidate zone options each representing an initial measurement region characterized by one or more initial values of one or more zone parameters; and execute a zone optimization process for each candidate zone option using the image data, to determine a zone option characterized by one or more optimized values for the one or more zone parameters. The zone option represents an optimal configuration that, when applied to the image data, yields optimal measurement performance for the candidate zone option.

The measurement module 106 can be configured to compute an overlay measurement between the first layer and the second layer for different combinations of the first zone options and the second zone options, and select a combination of a first zone option and a second zone option which provides optimal overall performance for the overlay measurement, such as precision and/or correlation, as will be detailed below with reference to FIG. 2.

In some cases, the functional modules included in the zone generation system can be regarded as part of an examination recipe usable for performing runtime examination for semiconductor specimens to be examined.

It is to be noted that while certain embodiments of the present disclosure refer to the processing circuitry 102 being configured to perform the above-recited operations, the functionalities/operations of the aforementioned functional modules can be performed by the one or more processors in processing circuitry 102 in various ways. By way of example, the operations of each functional module can be performed by a specific processor, or by a combination of processors. The operations of the various functional modules, such as the identification of candidate zone options, the execution of the zone optimization process, the computation of the overlay measurement, and the selection of zone option combination etc., can thus be performed by respective processors (or processor combinations) in the processing circuitry 102, while, optionally, these operations may be performed by the same processor. The present disclosure should not be limited to being construed as one single processor always performing all the operations.

In some cases, additionally to system 101, the examination system 100 can comprise one or more additional examination modules, such as, e.g., metrology module, defect detection module, nuisance filtration module, Automatic Defect Review (ADR) module, Automatic Defect Classification (ADC) module, and/or other examination modules which are usable for examination of a semiconductor specimen. The one or more examination modules can be implemented as stand-alone computers, or their functionalities (or at least part thereof) can be integrated with the examination tools 120. In some cases, the output of system 101, e.g., the selected zone option combination, and/or the overlay measurement, can be provided to the one or more additional examination modules for further processing.

According to certain embodiments, system 100 can comprise a storage unit 122. The storage unit 122 can be configured to store any data necessary for operating system 101, e.g., data related to input and output of system 101, as well as intermediate processing results generated by system 101. By way of example, the storage unit 122 can be configured to store the images and/or derivatives thereof produced by the examination tool 120. System 100 can also comprise a design data server 128 configured to store design data and design images derived therefrom. Accordingly, the input data as required can be retrieved from the storage unit 122 and design data server 128, and provided to the processing circuitry 102 for further processing. The output of system 101, such as, e.g., the selected zone option combination, and/or the overlay measurement, can be sent to storage unit 122 to be stored.

In some embodiments, system 100 can optionally comprise a computer-based Graphical User Interface (GUI) 124 which is configured to enable user-specified inputs related to system 101. For instance, the user can be presented with a visual representation of the specimen (for example, by a display forming part of GUI 124), including the design data and/or image data of the specimen, etc. The user may be provided, through the GUI, with options of defining certain operation parameters. The user may also view at least part of the operation results or intermediate processing results, such as, e.g., the various zone options, and/or the overlay measurement, etc., on the GUI.

In some cases, system 101 can be further configured to send, via I/O interface 126, the operation results to the examination tools 120 for further processing. In some cases, system 101 can be further configured to send the results to external systems (e.g., Yield Management System (YMS) of a fabrication plant (fab)). A yield management system (YMS) in the context of semiconductor manufacturing is a data management, analysis, and tool system that collects data from the fab, especially during manufacturing ramp-ups, and helps engineers find ways to improve yield. A YMS helps semiconductor manufacturers and fabs manage high volumes of production analysis with fewer engineers. These systems analyze the yield data and generate reports. A YMS can be used by Integrated Device Manufacturers (IMD), fabs, fabless semiconductor companies, and Outsourced Semiconductor Assembly and Test (OSAT).

Those versed in the art will readily appreciate that the teachings of the presently disclosed subject matter are not bound by the system illustrated in FIG. 1. Each system component and module in FIG. 1 can be made up of any combination of software, hardware, and/or firmware, as relevant, executed on a suitable device or devices, which perform the functions as defined and explained herein. Equivalent and/or modified functionality, as described with respect to each system component and module, can be consolidated or divided in another manner. Thus, in some embodiments of the presently disclosed subject matter, the system may include fewer, more, modified and/or different components, modules, and functions than those shown in FIG. 1.

Each component in FIG. 1 may represent a plurality of the particular components, which are adapted to independently and/or cooperatively operate to process various data and electrical inputs, and enable operations related to a computerized examination system. In some cases, multiple instances of a component may be utilized for reasons of performance, redundancy, and/or availability. Similarly, in some cases, multiple instances of a component may be utilized for reasons of functionality or application. For example, different portions of the particular functionality may be placed in different instances of the component.

It should be noted that the examination system illustrated in FIG. 1 can be implemented in a distributed computing environment, in which one or more of the aforementioned components and functional modules shown in FIG. 1 can be distributed over several local and/or remote devices. By way of example, the examination tools 120 and the system 101 can be located at the same entity (in some cases hosted by the same device) or distributed over different entities, depending on specific system configurations and implementation needs.

In some examples, certain components utilize a cloud implementation, e.g., are implemented in a private or public cloud. Communication between the various components of the examination system, in cases where they are not located entirely in one location or in one physical entity, can be realized by any signaling system or communication components, modules, protocols, software languages, and drive signals, and can be wired and/or wireless, as appropriate.

It should be further noted that in some embodiments at least some of the examination tools 120, storage unit 122, design data server 128 and/or GUI 124 can be external to the examination system 100 and operate in data communication with systems 100 and 101 via I/O interface 126. System 101 can be implemented as stand-alone computer(s) to be used in conjunction with the examination tools, and/or with the additional examination modules as described above. Alternatively, the respective functions of the system 101 can, at least partly, be integrated with one or more examination tools 120, thereby facilitating and enhancing the functionalities of the examination tools in examination-related processes.

While not necessarily so, the process of operations of systems 101 and 100 can correspond to some or all of the stages of the methods described with respect to FIGS. 2-5. Likewise, the methods described with respect to FIGS. 2-5 and their possible implementations can be implemented by systems 101 and 100. It is therefore noted that embodiments discussed in relation to the methods described with respect to FIGS. 2-5 can also be implemented, mutatis mutandis, as various embodiments of the systems 101 and 100, and vice versa.

As described above, a semiconductor specimen is typically made of multiple layers. The examination process of a specimen can be performed a multiplicity of times during the fabrication process of the specimen, for example following certain processing steps of specific layers. For the purpose of illustration only, certain embodiments of the following description are described with respect to at least a first layer and a second layer of a specimen. Those skilled in the art will readily appreciate that the specimen can comprise more than two layers, and the teachings of the presently disclosed subject matter can be performed for any given layers of the specimen where overlay metrology is relevant. The present disclosure should not be limited to the number of layers comprised in the specimen and/or the specific layer(s) to be examined.

Referring to FIG. 2, there is illustrated a generalized flowchart of automatic zone generation for overlay metrology in accordance with certain embodiments of the presently disclosed subject matter.

Initially, design data of a semiconductor specimen can be obtained (202) (e.g., by the zone generation module 104 of the processing circuitry 102). The specimen comprises at least a first layer and a second layer, which are the layers of interest for which overlay measurements are to be determined. It is to be understood that the terms “first layer” and “second layer” do not necessarily indicate an exact sequential order of layers; rather, they serve to differentiate between the two layers of interest. In some embodiments, these layers may also be referred to as a lower layer and an upper layer based on their relative positions within the specimen, but such terminology is provided solely for illustrative purposes and is not intended to impose any limitation on the present disclosure.

The design data represents the intended geometrical layout of device features on the specimen, specifying positions, shapes, and dimensions of design elements. The design data may be stored or provided in various standard formats, such as computer-aided design (CAD) layouts. By way of example, the CAD design data may be represented as a set of polygons that collectively describe the geometrical layout of the device features. In this representation, each polygon defines the boundary of a feature, and the collection of these polygons forms a complete description of the semiconductor layout.

In addition to the design data, corresponding image data of the specimen can be obtained (e.g., by the zone generation module 104) as part of the input data. The image data comprises one or more actual images of the specimen acquired from an examination tool (e.g., the examination tool 120), such as a scanning electron microscope (SEM), an optical microscope, or another imaging modality. These images capture the real-world appearance of the specimen's surface at locations corresponding to the design data. Unlike the design data, which represents the intended layout, the image data reflects the physical conditions of the specimen, including any process variations, imaging artifacts and noises, etc.

By way of example, in some cases, one image can be acquired, representative of both the first layer and the second layer. In some other cases, two different images can be acquired by an electron beam tool, such as a SEM tool, including a secondary electron (SE) image capturing the features on a surface layer (e.g., an upper later), and a backscattered electron (BSE) image capturing the features on a lower layer. The SEM tool used herein can be, e.g., critical dimension scanning electron microscopes (CD-SEM) configured to perform metrology operations with respect to structural features of a specimen based on the captured images.

Next, a plurality of first zone options for the first layer and a plurality of second zone options for the second layer can be provided (204) (e.g., by the zone generation module 104). The zone options are generated separately for the first layer and for the second layer. Specifically, for each of the first layer and the second layer, a plurality of candidate zone options can be identified (206) based on the design data. Each candidate zone option represents an initial measurement region that is characterized by one or more initial values of one or more zone parameters. These candidate zone options serve as preliminary regions in which the center-of-symmetry (COS) can later be determined for computing the overlay measurement. They are derived directly from the design data, ensuring that each candidate zone option initially encompasses at least a portion of the target features specified in the intended layout.

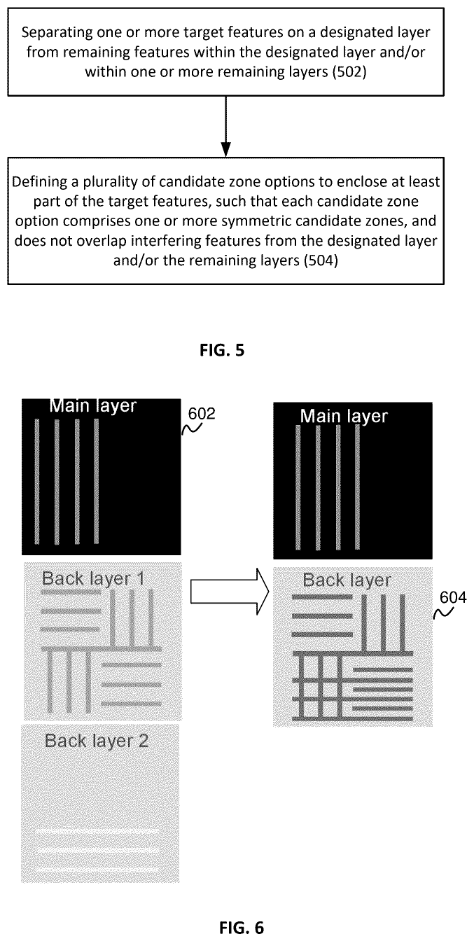

The identification of candidate zone options can be performed using various methods. For instance, FIG. 5 illustrates a generalized flowchart of an identification process for candidate zone options in accordance with certain embodiments of the presently disclosed subject matter.

As the identification process is executed separately for the first layer and the second layer, each layer is treated as a designated layer during this stage. For each designated layer, one or more target features on the designated layer can be separated (502) from the remaining features present either within the designated layer or within one or more remaining layers of the design data (or in some cases, from both). This separation step can be essential for isolating the features that are relevant for overlay measurement.

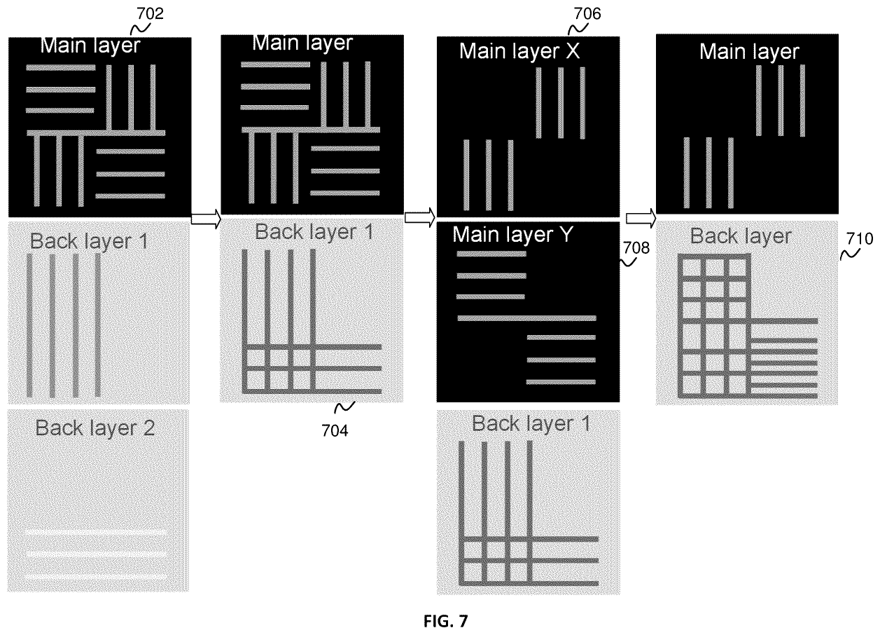

FIG. 6 and FIG. 7 illustrate an example of target feature separation on different layers based on an exemplified specimen in accordance with certain embodiments of the presently disclosed subject matter. These two figures demonstrate that different layers of a semiconductor specimen are separately treated as the designated layer (referred to as the main layer in the figures), and the remaining layers are regarded as background layers (referred to as back layers in the figures). The goal is to isolate the target features in each main layer while grouping all other features, whether from the same layer or from other layers, into a single back layer.

As shown in FIG. 6, the exemplary specimen includes three physical layers: (i) a lower layer regarded as a main layer, i.e., the designated layer (labeled as “main layer”, which is a lower layer in position relative to the first back layer), (ii) a first back layer (labeled as “back layer 1”), and (iii) a second back layer (labeled as “back layer 2”).

The main layer contains four vertical lines, as shown in 602. These four vertical lines represent the target features on this layer for which overlay measurements (e.g., via COS determinations) may be performed. These vertical lines are separated from any other features that might appear on the same physical layer or from the back layers 1 and 2.

As shown in 604, the first back layer and the second back layer are merged to form a single back layer. The lines from both back layers, horizontal or otherwise, are grouped together so that any potential interference or overlapping features from these layers are collectively considered as background. By designating the lower layer as the main layer, all features in the remaining layers (back layer 1 and back layer 2) are treated as a single combined background layer, ensuring that the target features (i.e., the four vertical lines) are distinctly isolated from other features.

In FIG. 7, an upper layer, which is referred to as the first back layer in FIG. 6, is designated as the main layer, as illustrated in 702. The other two layers serve as the back layers 1 and 2. The main layer contains both vertical and horizontal lines. However, only the vertical lines serve as the target features for measurement, as the overlay measurement in this example is targeted for the x direction.

The features in the two back layers are grouped together, as illustrated in 704 The vertical lines on the main layer, acting as the target features, are separated from the remaining features, as illustrated in 706. The remaining features from the main layer, i.e., the horizontal lines in 708, are merged together with the grouped features from the two back layers as illustrated in 704, ultimately forming a combined back layer 710.

This feature separation approach ensures that any non-target features, whether they originate from the main layer itself or from the other layers, are treated collectively as a single back layer. The system thus preserves the vertical lines (in 706) as the primary region of interest for subsequent measurement zone generation and overlay analysis.

Referring back to FIG. 5, following feature separation, a plurality of candidate zone options can be defined (504) to enclose at least part of the one or more target features. In addition, each candidate zone option is defined to include one or more symmetric candidate zones. The symmetry of candidate zones can be essential as it facilitates accurate COS determination. In addition, each candidate zone option is defined such that it does not overlap with interfering features, whether these interfering features originate from within the designated layer itself or from one or more of the remaining layers. By ensuring that the candidate zone options are both symmetrically arranged and free of interference, the system establishes a robust foundation for subsequent optimization steps that refine these candidate zones into optimized measurement zones in terms of providing optimal overlay measurement performance.

Continuing with the example in FIGS. 6 and 7, FIG. 8 illustrates examples of candidate zone options separately defined for the two main layers in accordance with certain embodiments of the presently disclosed subject matter.

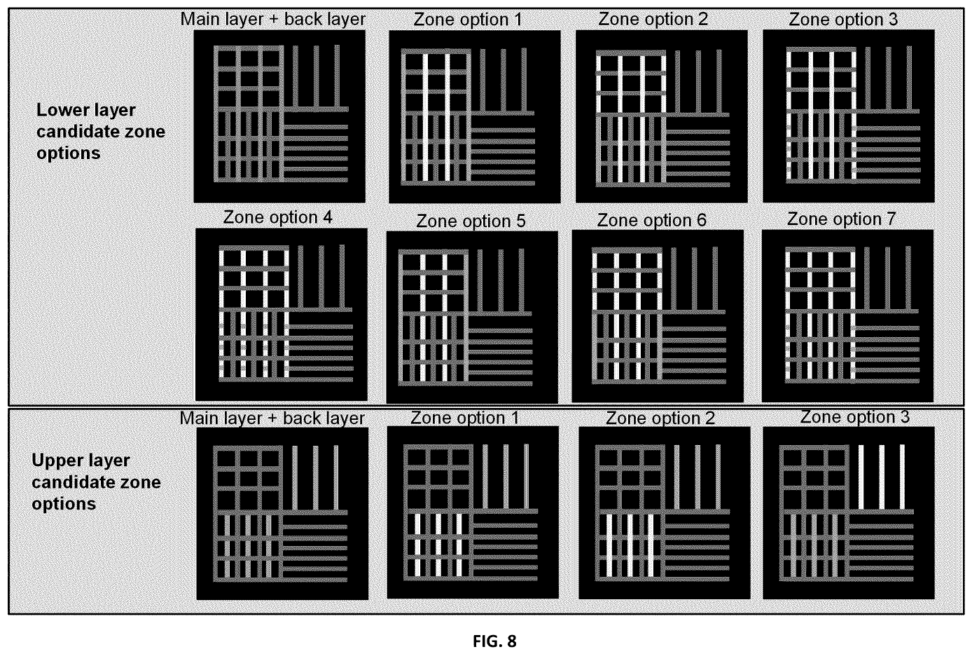

FIG. 8 presents two distinct sections. The top section corresponds to a scenario in which the lower layer is designated as the main layer (as illustrated in FIG. 6), while the bottom section corresponds to a scenario in which the upper layer is designated as the main layer (as illustrated in FIG. 7). Each section begins with an illustration labeled “Main layer +back layer,” followed by a series of candidate zone options. These candidate zone options represent different ways in which candidate measurement regions can be defined on the main layer while accounting for the remaining features in the back layer.

Specifically, the leftmost image in the top section shows the lower layer designated as the main layer, superimposed with its back layer. In the example, the main layer contains vertical lines as target features, while the back layer is a composite of the remaining two physical layers. This composite background ensures that any non-target features from the main layer itself or from the other layers are grouped together as a single back layer.

The next images in the top section (labeled “Zone option 1,” “Zone option 2,” “Zone option 3,” etc.) depict different candidate zone options (illustrated with brighter gray level colors) that the system can define for measuring overlay. Each zone option encloses at least a portion of the four vertical lines in the main layer, potentially selecting and/or segmenting subsets of the target features such that the resulting regions/zones are symmetric while excluding interfering features from the back layer.

By way of example, in zone option 1, the two middle vertical lines are selected as a whole, while in zone option 5, the same two vertical lines are segmented where their intersection portions with the interfering horizontal lines are excluded. By way of another example, zone options 3, 4, and 7 demonstrate alternative segmentations of the four vertical lines, each excluding different sets of interfering features.

The bottom section similarly depicts a scenario in which the upper layer is designated as the main layer and only the vertical lines are treated as target features. Like the top section, the images labeled “Zone option 1,” “Zone option 2,” “Zone option 3,” etc., illustrate multiple candidate zone options for overlay measurement on the upper layer.

This variability of enumerating different candidate zone definitions allows the system to be able to evaluate multiple candidate options with different zone configurations, eventually determining which candidate zone option and configuration yields the optimal measurement results, as will be described further below.

Referring back to FIG. 2, as described above with reference to block 206, each candidate zone option as exemplified above represents an initial measurement region characterized by one or more initial values of one or more zone parameters. By way of example, the one or more zone parameters can comprise one or more of a zone shift parameter, a zone pitch parameter, a zone size parameter, and/or possibly other parameters that can characterize a specific configuration of the zones in the candidate zone options.

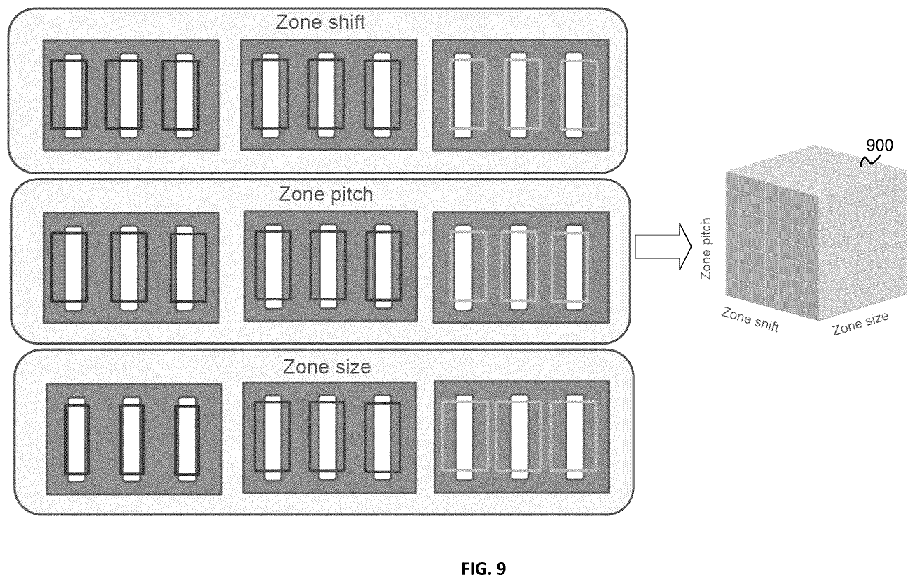

A zone optimization process can be executed (208) for each candidate zone option using the image data, to determine a zone option (also referred to herein as optimized zone option, to differentiate from the initial candidate zone option) characterized by one or more optimized values for the one or more zone parameters. The zone option represents an optimal configuration of the candidate zone option which, upon being applied on the image data, yields optimal measurement performance for the candidate zone option (among a set of configurations in the permutation array, as will be described below in detail with reference to FIG. 3 and FIG. 9).

For instance, the optimal measurement performance for the candidate zone option may be defined as the configuration that, when applied to the image data, meets or exceeds predetermined criteria for overlay metrology. In other words, it refers to a local performance of an individual measurement zone when applied to the image data, relative to the overall performance of overlay measurement which will be detailed below with reference to block 212. In particular, this performance can be evaluated based on one or more measurement metrics—such as the symmetry center metric and the image symmetry metric, along with their corresponding robustness values, as will be detailed below.

FIG. 3 illustrates a generalized flowchart of a zone optimization process in accordance with certain embodiments of the presently disclosed subject matter.

For each candidate zone option, the initial values of the one or more zone parameters can be varied (302) to generate a permutation array of modified zone options (also referred to zone configurations).

FIG. 9 illustrates examples of zone parameters and how they can be varied to create a permutation array of zone configurations in accordance with certain embodiments of the presently disclosed subject matter.

FIG. 9 depicts three separate rows, each focusing on a distinct zone parameter: shift, pitch, and size. These parameters can be used to configure the candidate zones, and can be applied individually or in combination to generate multiple variations (or permutations) of a candidate zone option. By systematically varying the values of these parameters, the system can explore different measurement region/zone configurations to determine which one yields the most accurate and robust overlay measurement.

Specifically, the present example illustrates three vertical line structures as the target features. The zone parameters are used to configure a given candidate zone option, which are represented by three rectangular shapes, each enclosing a portion of a line structure.

The top row demonstrates three different zone configurations resulting from varying the parameter of zone shift. Zone shift refers to translating the zone's position relative to the underlying target features. As shown, the rectangular shapes (representing measurement zones in the zone option) move from left to right along the measured direction (x direction in this example) relative to the target features.

By shifting the zone slightly, the system can see if small positional changes improve the measurement quality upon applying the zone options on image data. For example, a zone that is shifted too far may include unwanted features or miss critical parts of the target. Conversely, a carefully tuned shift can isolate the signal of interest more effectively.

The middle row demonstrates three different zone configurations resulting from varying the parameter of zone pitch, representing the distance or spacing between the zones. As shown, the spacing between the rectangular shapes is increased or decreased, showing different intervals between them. By adjusting the pitch, the system can ensure that each zone encloses a relevant portion of the target feature while avoiding overlap or interference from neighboring structures. For instance, the pitch can be adjusted in cases where there is a change in the pitch between the design data and the real image. A larger pitch spreads the zones further apart, while a smaller pitch clusters them more closely.

The bottom row shows how the parameter of zone size impacts zone configurations. Size indicates the dimensions of the zone in the measured direction (and is potentially perpendicular to it, depending on the application). A larger zone might capture more of the target feature, but also risk including unwanted elements. A smaller zone may isolate the feature more precisely, but could exclude important signal regions if it is too narrow.

In the present example, as shown, the zone width of each zone varies from narrow to wide along the measurement direction. Finding the right size is key to balancing the need for capturing enough signal from the feature with the goal of excluding interfering noise or overlapping structures.

When varying the values of these zone parameters, a three-dimensional (3D) permutation array 900 that combines all three parameters—zone shift, zone pitch, and zone size—can be created. Each axis of the 3D array corresponds to one of the zone parameters, and each discrete position (or “cell”) within the array represents a unique configuration of the candidate zone option, also referred to as a modified zone option with modified/varied zone parameter values. For instance, one cell might correspond to a particular shift value, a specific pitch setting, and a chosen size. By systematically traversing this permutation array, the system can evaluate every combination of parameter values and assess how each configuration performs in terms of measurement quality (e.g., signal symmetry, robustness, noise minimization). This comprehensive search ensures that no potentially optimal configuration is overlooked and that the final zone option is selected based on real-world performance metrics when applied to the image data.

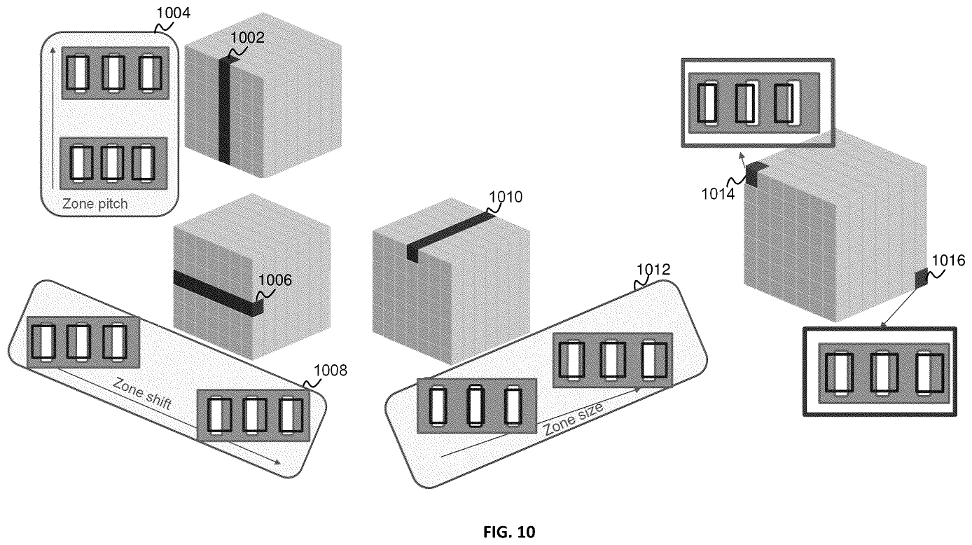

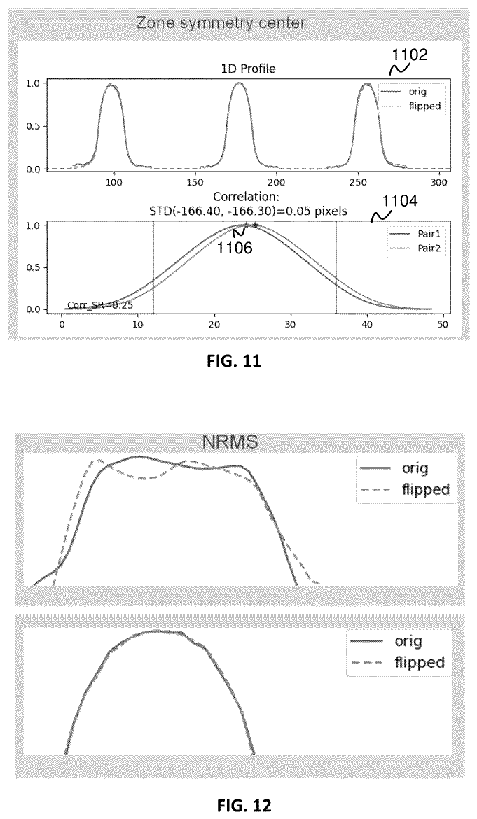

FIG. 10 illustrates further details of the 3D permutation array of zone configurations in accordance with certain embodiments of the presently disclosed subject matter.

This figure shows how different slices or cross-sections of the permutation array can be visualized. Each cell within the 3D array corresponds to a unique configuration of the candidate zone option, meaning a specific shift value, pitch value, and size value. As the cells were derived by varying the values of these parameters from the initial values, each cell is also referred to as a modified zone option of the initial candidate zone option.

By way of example, the dark slice 1002 indicates varying the parameter of zone pitch, while fixing the value of the other two parameters. Two specific configurations from this slice are exemplified in 1004, one with relatively small spacing, while the other with larger spacing between the zones.

Similarly, slice 1006 represents a different slice of the 3D array, fixing zone pitch and zone size, while allowing zone shift to vary. Two specific configurations from this slice are exemplified in 1008, one with relative shift of the zones to the left, while the other with relative shift to the right. Slice 1010 represents another slice where the values of zone size are varied. 1012 illustrates one specific configuration with wider zones, while the other has narrower zones.

In particular, references 1014 and 1016 illustrate two specific cells (or corners) in the array where different combinations of zone shift, zone pitch, and zone size are set. Each cell corresponds to a unique configuration of these parameters. For instance, the configuration represented by reference 1014 might apply the smallest zone size with the largest pitch and largest shift to the left from all possible permutations, whereas the configuration at reference 1016 might employ the largest zone size, the smallest pitch, and the largest shift to the right from all possible permutations.

In practice, each cell (representing a specific configuration, also referred to as a specific modified zone option) is applied to the specimen's image data, to compute measurement metrics. Because the 3D array spans the full range of parameter values for shift, pitch, and size, the system can exhaustively evaluate every potentially useful zone configuration.

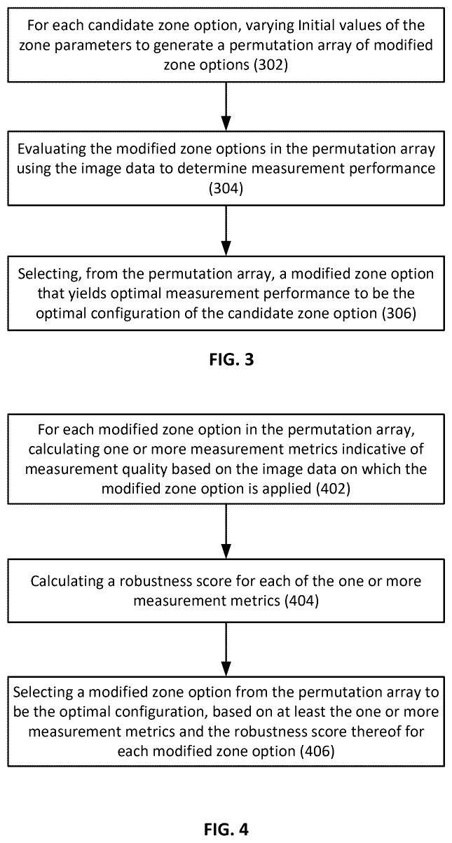

Continuing with the description of FIG. 3, the modified zone options in the permutation array can be evaluated (304) using the image data of the specimen to determine measurement performance. The measurement performance can be evaluated based on certain predetermined criteria such as measurement metrics and their robustness values, as will be described with reference to FIG. 4. A modified zone option that yields optimal measurement performance can be selected (306) from the permutation array to be the optimal configuration of the candidate zone option.

FIG. 4 illustrates a generalized flowchart of an evaluation process of the modified zone options in accordance with certain embodiments of the presently disclosed subject matter.

Specifically, for each modified zone option in the permutation array, one or more measurement metrics indicative of measurement quality can be calculated (402) based on the image data on which the modified zone option is applied. As described, for the purpose of evaluation, each modified zone option is applied to the image data (e.g., the SEM or optical microscope images) to compute the measurement metrics. This application may involve overlaying the zone boundaries of the modified zone option onto the image data to isolate the target feature(s) in the images and exclude interfering structures.

One or more measurement metrics are then computed to gauge how effectively the zone captures the desired feature(s) without introducing noise or interference. The measurement metrics can be indicative of the measurement performance of image representation of the target features within the modified zone option. By way of example, the measurement metrics can comprise a symmetry center metric and/or an image symmetry metric.

The symmetry center (also referred to as COS) metric can indicate how symmetrical the image feature appears within the zone, often used for COS calculations. FIG. 11 illustrates an example of calculating the symmetry center metric in accordance with certain embodiments of the presently disclosed subject matter.

FIG. 11 continues with the example of candidate zone options for the three vertical lines as target features, as illustrated in FIGS. 9 and 10. As the candidate zone option comprises two pairs of symmetric candidate zones (the middle zone itself as the first pair, and the left and right zones forming the second pair), the permutation array will be derived for each pair separately. Accordingly, the symmetry center metric will also be computed separately for each pair.

Specifically, for each pair of symmetric zones, a cross-sectional 1D gray level (GL) profile can be extracted for the enclosed structures in the zones. This profile is essentially an intensity plot, where the X-axis corresponds to the spatial position along the features, and the Y-axis represents the GL intensity at each position. After obtaining the original 1D profile, the system creates a flipped version of the profile by mirroring it horizontally. This mirrored profile is superimposed to illustrate how it compares to the original profile when shifted along the X-axis, as illustrated in 1102. The COS can be identified by performing correlation between the original GL profile and a flipped profile thereof.

For purpose of identifying the COS, the flipped profile can be shifted incrementally along the X direction relative to the original GL profile. The correlation values at each position are calculated, to obtain a correlation graph 1104. The graph typically shows a peak correlation where the original and flipped profiles align best. This peak signifies the point of highest symmetry in the intensity distribution. The correlation process can be implemented using various methods, such as convolution or cross-correlation, depending on the specific algorithm requirements. The position 1106 on the X-axis of the correlation graph, where the peak occurs, corresponds to the shift between the original profile and the flipped profile.

Because the profiles are mirrored, the total shift measured is twice the actual offset of the symmetry center from the midpoint. For instance, the position 1106 on the X axis represents a shift Δ₁ that the flipped profile moved relative to the original profile, which is twice of the actual shift of the COS. Therefore, the COS δ₁ of the enclosed structures in the zones can be derived as: δ₁=Δ₁/2.

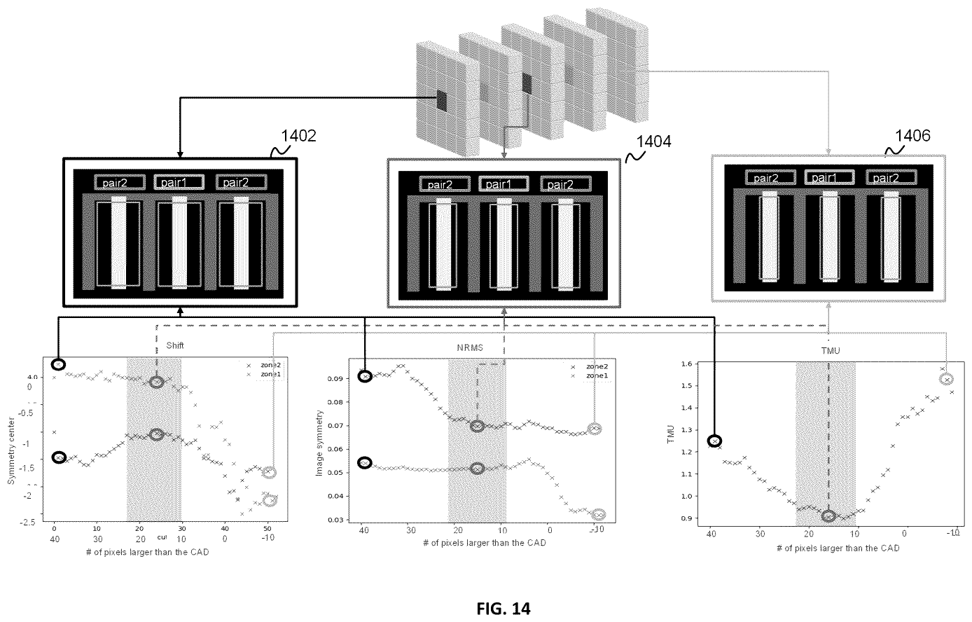

In the present example, since the zone option includes two pairs of symmetric zones, the system repeats the above procedure for each pair. This yields two separate COS values, one for each pair of zones, as illustrated in the correlation graph 1104. In some embodiments, the system can further evaluate how aligned the two COS values are, indicating the overall symmetry of the feature within the zone. A large discrepancy between the two COS values might indicate asymmetry or interference, while close alignment suggests a well-defined symmetry center. The alignment (or difference) between these COS values is also referred to as the symmetry center difference metric, as will be detailed below with reference to FIG. 14.

In addition to or in lieu of the symmetry center metric as described above, the measurement metrics can include an image symmetry metric. The image symmetry metric can quantify the signal quality or noise level in a measurement zone. For instance, the image symmetry metric can be implemented using a normalized root mean square (NRMS). FIG. 12 illustrates an example of an NRMS metric in accordance with certain embodiments of the presently disclosed subject matter.

FIG. 12 presents two examples of overlaying an original signal and its flipped counterpart. Each example shows how closely (or loosely) these signals align, providing insight into the image symmetry of the zone. The top graph corresponds to a high NRMS value, whereas the bottom graph corresponds to a low NRMS value.

Specifically, in the top graph, the solid curve (labeled “orig”) and the dashed curve (labeled “flipped”) diverge significantly in certain regions. This divergence reflects a higher NRMS value, which implies greater discrepancy between the original and flipped signals. In particular, a high NRMS often indicates lower symmetry of image signals and typically a noisier or more distorted representation of the feature in the zone, suggesting that the zone may include extraneous signals and/or may not be centered accurately around the target structure.

In comparison, in the bottom graph, the two curves nearly overlap across most of the profiles, showing minimal deviation between the original and flipped signals. This close alignment translates to a lower NRMS value, meaning better signal symmetry and generally a cleaner, more consistent representation of the feature. In particular, a low NRMS could imply that the zone effectively isolates the target feature with minimal noise or interference, supporting more reliable calculations of the center of symmetry or other measurement metrics.

It is to be noted that the symmetry metric and the image symmetry metric (e.g., the NRMS metric) described herein are provided solely as illustrative examples of measurement metrics that can be used to evaluate the quality of the image signal within a measurement zone. It is to be understood that any suitable metrics or methods for assessing signal symmetry, noise level, or measurement quality may be employed, either in addition to or in lieu of the metrics explicitly described herein. The present disclosure is not to be limited by the specific examples of measurement metrics provided, and alternative approaches or algorithms that achieve similar evaluation functions are contemplated and included within the scope of the present disclosure.

Continuing with the description of FIG. 4, a robustness score can be calculated (404) for each of the one or more measurement metrics. In some embodiments, during the zone optimization process, each modified zone option (i.e., a cell in the permutation array) is evaluated not only by its measurement metrics or part thereof (e.g., symmetry center, and/or NRMS) but also by a robustness score of these metrics. The robustness score indicates how stable these metrics remain under small parameter variations (e.g., minor changes in zone shift, pitch, or size).

As described above, the system generates a 3D permutation array where each axis represents one of the zone parameters (e.g., shift, pitch, size). Each cell in this array corresponds to a unique combination of parameter values, and thus a unique modified zone option. To compute the robustness score for a given cell, the system considers a set of neighboring cells (i.e., zone configurations, or modified zone options) within the permutation array. These neighbors differ from the center cell by small increments in shift, pitch, or size, capturing how slight adjustments to the zone parameters affect measurement metrics.

In some embodiments, the system can calculate the standard deviation (STD) of each measurement metric (e.g., symmetry center, NRMS) across the center cell (e.g., a given modified zone option) and its neighbors (e.g., a set of neighboring modified zone options of the given modified zone option), and use it as the robustness score of the measurement metric. A low standard deviation indicates that the metric remains relatively constant even if the zone is shifted or resized slightly, implying high robustness. A high standard deviation suggests the metric is highly sensitive to small parameter changes, indicating low robustness. The robustness score can thus be used to quantify sensitivity of the one or more measurement metrics of a given modified zone option to variation/changes across the set of neighboring modified zone options.

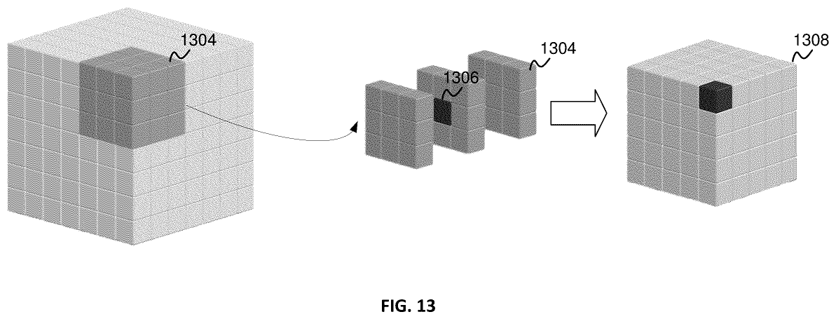

FIG. 13 shows a schematic illustration of how the robustness score is computed for a given cell in the 3D array in accordance with certain embodiments of the presently disclosed subject matter.

A given cell 1306 and a cube region 1304 representing a set of cell 1306's neighboring cells in the original 3D array of zone configurations are illustrated, where the cube region 1304 represents the set of neighboring zone configurations used to compute the standard deviation for a specific measurement metric.

Each cell within this cube region 1304 corresponds to a slightly altered zone configuration compared to the center cell 1306. The center cell 1306 represents the current cell whose robustness is being evaluated. The system gathers measurement metrics (e.g., COS, NRMS) from all these neighboring cells to calculate the standard deviation.

A resulting robustness array 1308 is illustrated, demonstrating a 3D array (possibly with reduced dimension) representing the robustness scores themselves. Each cell in this new array corresponds to the standard deviation value for a particular center cell in the original permutation array. It may be noted that the resulting robustness array can be smaller or adjusted in dimensions, as the boundary cells in the original array may not have enough neighbors to calculate its robustness score. For example, in cases where the dimension of the NRMS array is 7×7×7, and the cube region 1304 is in the dimension of 3×3×3, the robustness array 1308 may be in the dimension of 5×5×5.

By capturing how each metric fluctuates among neighboring parameter sets, the robustness score directly measures sensitivity of each measurement metric of a given zone configuration to variation/changes across the set of neighboring configurations. If a zone configuration's measurement metrics vary drastically with small parameter changes, that configuration is considered less robust.

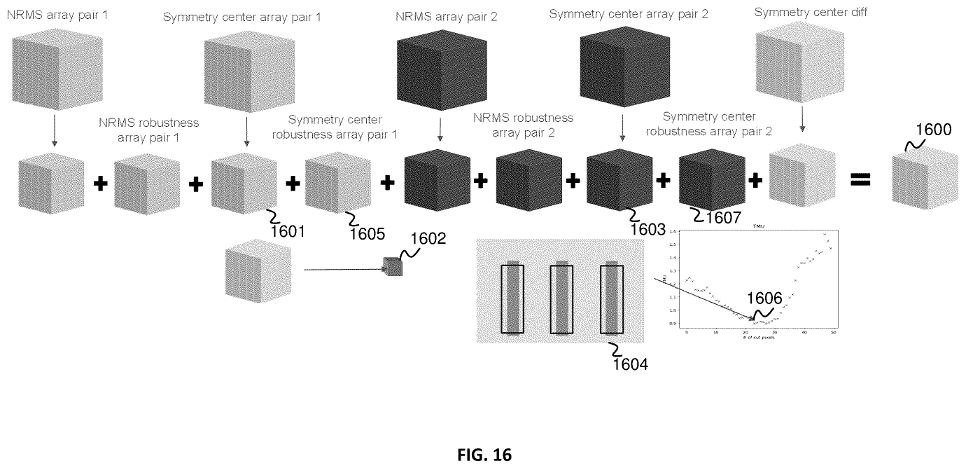

In certain embodiments, when selecting the optimal zone configuration, the system jointly considers the raw metric values (e.g., symmetry center and image symmetry) and the robustness scores thereof. As illustrated in FIG. 4, the system evaluates each modified zone option in the permutation array by calculating both its measurement metrics and its robustness scores. Based on at least some of these combined evaluations (e.g., at least some of the one or more measurement metrics and the robustness score thereof for each modified zone option), a modified zone option can be selected (406) from the permutation array as the optimal configuration. In some cases, the selection of the optimal configuration can be based on both the symmetry center metric and the image symmetry metric, along with their robustness scores. In some other cases, the selection can be based primarily on the image symmetry metric (without the symmetry center metric), while still accounting for the robustness scores of both the symmetry center metric and the image symmetry metric. By way of example, these varying criteria can be realized by assigning different weights to each metric and its robustness score when computing a composite evaluation for each configuration, as exemplified below with reference to FIG. 16.

Specifically, the measurement metrics reflect the immediate quality or performance of the measurement obtained from a modified zone option. In parallel, the robustness scores, which are derived from the standard deviation of these metrics over a set of neighboring configurations, quantify the stability of the measurement with respect to small variations in zone parameters.

The selected optimal zone configuration is the one that exhibits not only superior raw metric values, implying accurate and clear feature capture, but also high robustness, meaning its performance remains consistent under slight changes in parameters. This dual consideration ensures that the final zone option delivers reliable overlay measurements across variable processing and imaging conditions.

FIG. 14 illustrates an example of robustness analysis for varying zone size in accordance with certain embodiments of the presently disclosed subject matter.

This figure focuses on how robustness analysis is conducted when zone size varies (along the x-axis, labeled “# of pixels larger than CAD”) and how this variation affects shift (symmetry center, indicating where the COS is detected relative to a reference), NRMS (image symmetry, reflecting how well the zone captures a clean, symmetrical signal), and ultimately the TMU (total measurement uncertainty, also referred to as precision). The figure highlights three specific zone configurations 1402, 1404, 1406 applied on a zone option including two pairs of symmetric candidate zones (marked as pair 1 and pair 2 in the figure) and compares their performance in terms of measurement quality and robustness. Note that the metrics are calculated separately for the two pairs of symmetric candidate zones as illustrated in the graphs in FIG. 14.

Specifically, with zone configuration 1402 (the left example) where the zone width is the largest among the three, the symmetry center metric is high but inconsistent among its neighboring zone sizes, suggesting unstable robustness in shift. The high NRMS value indicates that the signal itself has relatively high noise or poor symmetry. Because of the inconsistent symmetry center metric and poor image symmetry quality, the overall measurement precision suffers, leading to a higher TMU.

Regarding zone configuration 1406 (the right example), where the zone width is the narrowest among the three, the symmetry center metric is low and inconsistent, and its neighboring configurations show greater variability, implying that the shift is not robust. Despite the relatively low NRMS, the instability in NRMS indicates this configuration is sensitive to small parameter changes. These result in high TMU.

In contrast, with zone configuration 1404 (the center example), the symmetry center metric for each pair remains steady across neighboring zone sizes. The signal quality, as indicated by a low NRMS, is strong, with minimal noise, and remains stable among adjacent configurations. Because both the symmetry center metric and NRMS are robust, the final TMU is minimized. This makes 1404 the most desirable zone configuration among the three.

The figure illustrates that even if a zone configuration has decent raw metric values (e.g., a good shift or a low NRMS), it must also remain stable when neighboring zone sizes are considered. The configuration that balances good raw metrics with robust stability (1404) achieves the lowest TMU, indicating best precision.

In some embodiments, each candidate zone option can comprise at least two pairs of symmetric candidate zones. In such embodiments, the target features within a candidate zone option are segmented into two distinct, symmetric groups. For instance, one pair may include a zone that encloses the central portion of the feature, while another pair may capture the outer portions. In the example of FIG. 14, the candidate zone option is divided into two pairs of symmetric candidate zones, marked as Pair 1 and Pair 2. Pair 1 may include a zone that encloses part of the central line structure, while Pair 2 may capture the two outer line structures. By organizing the candidate zone option into such symmetric pairs, the system can independently evaluate the measurement quality of each pair.

In such cases, the symmetry center metric and image symmetry metric, and the robustness score thereof, can be calculated for each pair of the at least two pairs of symmetric candidate zones.

In some embodiments, the optimization process can further refine the selection of the optimal zone configuration by calculating an additional parameter known as the symmetry center difference metric. This metric can be derived by comparing the symmetry center metrics obtained from the at least two pairs of symmetric candidate zones, as exemplified in the correlation graph 1104 of FIG. 11. For instance, in cases where there are more than two pairs, the standard deviation of all the symmetry centers can be calculated and used as the symmetry center difference value.

In such cases, the optimal configuration can be selected further based on the symmetry center difference metric. This means that the optimal zone configuration is selected not only based on the raw values of the symmetry center and image symmetry metrics and their robustness, but also on the degree of closeness/alignment between the COS values of the two symmetric pairs.

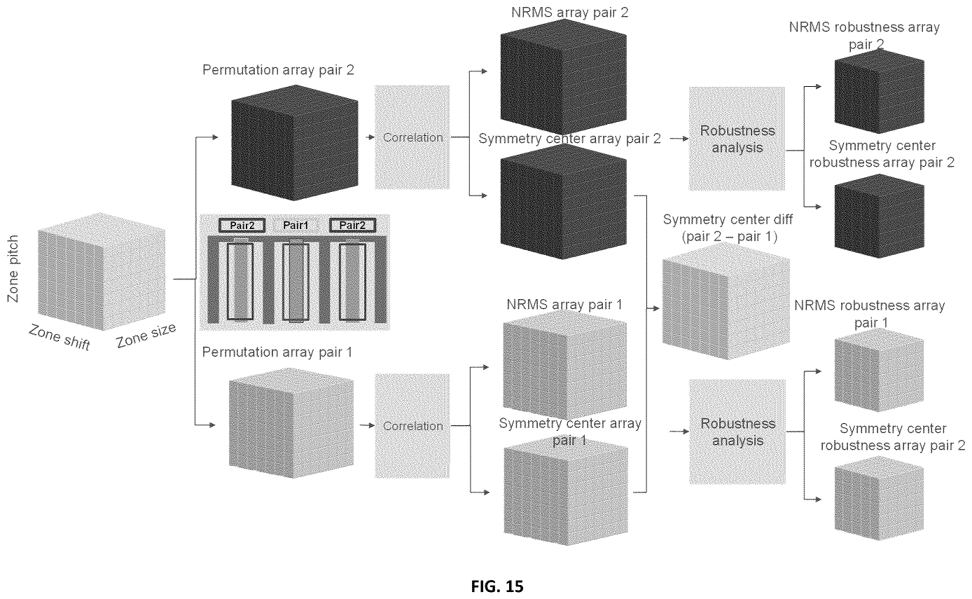

FIG. 15 illustrates a schematic flow of automatic zone generation for two pairs of symmetric zones in accordance with certain embodiments of the presently disclosed subject matter.

This figure demonstrates the generation process with respect to two pairs of symmetric zones (e.g., Pair 1 and Pair 2 as illustrated in the example of FIG. 14, each of which encloses a different segment of the target features) which are evaluated in parallel using measurement metrics and robustness analyses as described above.

Both pairs are subjected to a zone parameter variation (e.g., shift, pitch, size). By iterating over all possible combinations of these parameters, the system creates a 3D permutation array of zone configurations for Pair 1 and Pair 2 separately, as labeled “Permutation array pair 1” and “Permutation array pair 2”.

For each permutation array of the two pairs, correlation is performed for each cell (representing a specific zone configuration) once it has been applied on the image data, e.g., based on the original and flipped image signals as described above. This correlation helps compute the symmetry center and the NRMS for each cell in the 3D array.

Thus, the system calculates the symmetry center for each configuration in each permutation array, producing a symmetry center array for Pair 1 and another for Pair 2. Each cell in these arrays reflects how the center of symmetry is determined for that particular zone configuration.

Similarly, for each permutation array, the system calculates the NRMS values, which gauge the image symmetry or signal quality in the zone configurations. These NRMS values form an NRMS array for Pair 1 and an NRMS array for Pair 2. Each cell in these arrays corresponds to the NRMS value at a specific combination of shift, pitch, and size.

Next, for each metric array (NRMS or symmetry center), the system performs a robustness analysis by examining neighboring configurations. This analysis yields a robustness array, where each cell represents the standard deviation of that metric among local neighbors in the permutation array. A lower standard deviation indicates high robustness, meaning the metric remains stable under small parameter variations.

Since there are two pairs, each pair's metrics (NRMS, symmetry center) are individually evaluated for robustness. This results in four main robustness arrays, two for NRMS (Pair 1, Pair 2) and two for symmetry center (Pair 1, Pair 2).

Therefore, the figure shows two parallel tracks: one for Pair 1 and one for Pair 2. Each track involves generating a permutation array of zone configurations, performing correlation, calculating NRMS and symmetry center arrays, and finally computing robustness arrays. Once both pairs'metrics and robustness scores are computed, the system combines these results to identify which zone configurations produce the best overall performance.

In addition, as illustrated, the symmetry center between Pair 1 and Pair 2 can be compared, to generate a symmetry center difference array to evaluate how closely the symmetry center from the two symmetric pairs aligns. This array can be used in conjunction with the above arrays to assess the best zone configuration.

FIG. 16 illustrates how the best configuration is assessed in accordance with certain embodiments of the presently disclosed subject matter.

This figure demonstrates the final step in the optimization process. It shows how multiple arrays, NRMS arrays, Symmetry Center arrays, and their corresponding robustness arrays, as well as the symmetry center difference array, are combined for each pair of symmetric zones (Pair 1 and Pair 2).

By way of example, the multiple arrays can be combined, e.g., by summation with assigned weights, to produce a single composite score for each zone configuration. For instance, in some cases, the weight of the symmetry center arrays (e.g., 1601 and 1603) may be assigned zero or low weight, since these arrays may be considered as providing limited information with respect to noise and measurement quality. In comparison, the symmetry center robustness arrays (e.g., 1605 and 1607) can be given greater weight, as they quantify the stability of the measurement under small parameter variations, as detailed above with reference to FIG. 14. Each zone configuration in the permutation array thus receives a composite score that reflects the raw metric quality, the stability (robustness) of those metrics, and the difference between the symmetry centers. The combination ultimately generates a score array 1600, a single measure indicating overall overlay-measurement performance for each permutation (e.g., the precision and accuracy of the measurement).

The best-scoring cell 1602 in this array 1600 corresponds to the zone configuration 1604 for a given candidate zone option that delivers the most favorable balance of high-quality metrics, strong robustness, and minimal COS mismatch between pairs. As illustrated, this best permutation is correlated with a low TMU 1606, effectively yielding high precision in overlay measurement.

As described above with reference to block 208, each candidate zone option undergoes the zone optimization process, calculating measurement metrics (e.g., symmetry center, NRMS) and their robustness. The best permutation (i.e., the zone configuration that achieves the highest combined score which is typically associated with a low TMU or precision) is then selected. This best permutation effectively becomes the optimized zone option for that candidate zone option, ensuring reliable and repeatable overlay measurements.

As the zone optimization process is executed for each of the plurality of candidate zone options defined on a given layer (e.g., the first layer or the second layer), once optimization is complete, each candidate zone option on the first (e.g., lower) layer yields an optimized zone option. Collectively, these form the plurality of optimized first zone options (also referred to as first zone options), all of which can be used in subsequent overlay measurements. In parallel or sequentially, the system processes the second (e.g., upper) layer's candidate zone options. For each candidate zone option, the best permutation is identified, giving rise to a plurality of optimized second zone options (also referred to as second zone options), as described above with reference to block 204. These second zone options can be paired with the first layer's optimized options to compute overlay measurements.

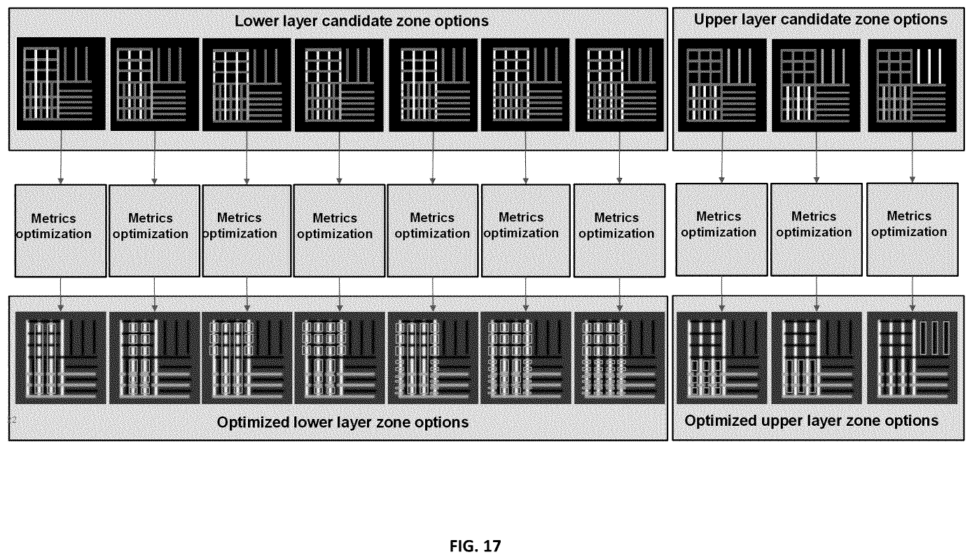

FIG. 17 continues the example introduced in FIG. 8, where multiple candidate zone options exist for both the lower and upper layers of a specimen. FIG. 17 illustrates the plurality of optimized lower zone options and optimized upper zone options obtained for the candidate zone options of the lower layer and the upper layer of the specimen.

The top section corresponds to the lower layer candidate zone options (on the left) and the upper layer candidate zone options (on the right). Each thumbnail image represents a distinct candidate zone option, as illustrated previously in FIG. 8. For instance, there may be seven options for the lower layer and three for the upper layer.

The middle section depicts “Metrics Optimization”, representing the zone optimization process for each candidate zone option, including the calculation of measurement metrics (symmetry center, NRMS), their robustness, and any additional metrics (e.g., symmetry center difference), as described above with reference to FIGS. 15 and 16. During this process, the system identifies the best permutation—the combination of zone parameters (e.g., shift, pitch, size) that yields optimal measurement performance and stability for each candidate zone option.

The bottom section shows the final, optimized zone options for both the lower and upper layers. Each optimized option directly corresponds to one of the candidate zone options from the top section. For example, if the lower layer had seven candidate options, the bottom row now displays seven corresponding optimized zones. The upper layer had three candidate options, so it yields three optimized zones.

These optimized zones are then applied to the specimen's image data for computing overlay measurements with higher precision and reliability. For instance, it can measure overlay by pairing any of the first (lower) layer's optimized zones with any of the second (upper) layer's optimized zones.

Referring back to FIG. 2, once a plurality of first zone options for the first layer and a plurality of second zone options for the second layer are generated, the next step is to compute (210) (e.g., by the measurement module 106) the overlay measurement between the first layer and the second layer for different combinations of the first zone options and the second zone options.

Each optimized zone option represents a refined/optimized measurement region that captures the target feature on its corresponding layer with optimal performance (optimal for the corresponding candidate zone option, as determined by previous optimization processes). The overlay measurement can be determined, e.g., by comparing the centers of symmetry (COS) or other key metrics derived from the corresponding zones in the first and second layers. This comparison yields an overlay measurement that indicates the relative alignment between the two layers.

After computing overlay measurements for the different combinations of optimized zone options, a combination of a first zone option and a second zone option that provides optimal overall performance for the overlay measurement can be selected (212). As described above, relative to the measurement performance for the candidate zone option mentioned above, the overall performance for the overlay measurement refers to a more global performance criterion that considers how well the paired zones from different layers work together to yield a good performance of overlay measurement.

In the specific example depicted in FIG. 17, the lower layer (first layer) has seven optimized zone options, and the upper layer (second layer) has three optimized zone options. Since each zone option from the first layer can be paired with each zone option from the second layer, a total of 21 unique combinations (7×3) can be formed. The system computes an overlay measurement for each of these 21 combinations. For example, one combination might pair the first optimized zone option from the lower layer with the second optimized zone option from the upper layer, and so on for all combinations. Once all 21 overlay measurements are computed, the system compares them using the predetermined performance metrics, such as precision, correlation, etc.

Precision in the context of overlay measurement can refer to the degree of consistency or repeatability of the measurement when repeated under identical conditions. High precision (represented by a lower precision value) indicates that the variation (or statistical spread) of repeated overlay measurements is minimal, ensuring reliable and repeatable process control.

Correlation refers to the degree of agreement between the overlay measurements obtained by the system and a reference or expected overlay value (such as a ground truth value). It is typically quantified by a correlation coefficient that measures the strength and direction of the linear relationship between the measured values and the reference values, indicating how closely the overlay measurement matches the intended design.

After the optimal combination of a first zone option and a second zone option is identified, this combination is stored within the system for future use. By way of example, the stored combination can be used as the measurement template or recipe for performing overlay measurements on one or more runtime specimens that share the same design data. By reusing the optimized combination, the system can quickly and reliably measure overlay during production/runtime, ensuring that the process remains consistent and that any deviations in layer alignment are promptly detected and corrected.

It is to be noted that examples illustrated in the present disclosure, such as, e.g., the exemplified layers, target features and zone options, the exemplified zone parameters, and the measurement metrics, etc., are illustrated for exemplary purposes, and should not be regarded as limiting the present disclosure in any way. Other appropriate examples/implementations can be used in addition to, or in lieu of the above.

Among the advantages of certain embodiments of the presently disclosed subject matter as described herein, is elimination of manual zone selection, which substantially reduces user dependency and subjectivity. By automating the process of identifying optimized zone options based on design data, the system minimizes inconsistencies introduced by manual selection, thereby ensuring symmetric and valid zone options and enhancing the repeatability and reliability of overlay measurements.

Among further advantages of certain embodiments of the presently disclosed subject matter as described herein, is the significant acceleration of the overlay measurement process. By automating the entire workflow—from candidate zone identification and parameter permutation through to robustness evaluation and optimal configuration selection, the system reduces time-to-insight and increases throughput in semiconductor process control, compared to conventional manual methods.

Among further advantages of certain embodiments of the presently disclosed subject matter as described herein, is the integration of design data with image data to refine candidate zone options. This dual-source approach enables the system to correct discrepancies between the idealized CAD layout and actual fabricated structures, resulting in more accurate measurement regions that better represent the true features on the wafer.

Among further advantages of certain embodiments of the presently disclosed subject matter as described herein, is the use of a multi-dimensional permutation array to systematically explore a wide range of zone configurations by varying parameters such as shift, pitch, and size. This comprehensive evaluation ensures that the system identifies the configuration that yields the most favorable measurement metrics for overlay metrology.

Among further advantages of certain embodiments of the presently disclosed subject matter is the evaluation of key measurement metrics, including a symmetry center metric and an image symmetry metric (e.g., NRMS), which provide a comprehensive assessment of the quality of the captured image features. This dual-metric evaluation facilitates the reliable selection of optimal zones that accurately capture the center of symmetry while minimizing noise and interference.

Among further advantages of certain embodiments of the presently disclosed subject matter as described herein, is the implementation of a robustness analysis that calculates robustness scores based on the standard deviation of measurement metrics across neighboring configurations. This feature ensures that the selected zone configuration remains stable and consistent under minor variations, thus significantly enhancing measurement precision.

Among further advantages of certain embodiments of the presently disclosed subject matter as described herein, is the capability to segment a candidate zone option into multiple symmetric pairs and calculate a symmetry center difference metric between these pairs. This approach enables the system to ensure consistency between different symmetric regions, thereby improving the overall accuracy and robustness of the overlay measurement.

Among the advantages of certain embodiments of the presently disclosed subject matter as described herein, is the ability to store and reuse the optimal zone configuration for runtime specimens that share the same design data. This capability ensures that once the best-performing configuration is determined, it can be consistently applied across multiple wafers, thereby reducing variability and enhancing production-level measurement consistency.

It is to be understood that the present disclosure is not limited in its application to the details set forth in the description contained herein or illustrated in the drawings.

In the present detailed description, numerous specific details are set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the present discussions, it is appreciated that throughout the specification discussions utilizing terms such as “obtaining”, “examining”, “providing”, “acquiring”, “generating”, “identifying”, “executing”, “computing”, “selecting”, “separating”, “defining”, “varying”, “evaluating”, “selecting”, “calculating”, “measuring”, or the like, refer to the action(s) and/or process(es) of a computer that manipulate and/or transform data into other data, said data represented as physical, such as electronic, quantities and/or said data representing the physical objects.

The terms “computer”, “computer-based system” or “computerized system” should be expansively construed to cover any kind of hardware-based electronic device with a data processing circuitry (e.g., digital signal processor (DSP), a graphics processing unit (GPU), a field programmable gate array (FPGA), including, by way of non-limiting example, the examination system, the zone generation system, and respective parts thereof disclosed in the present application. The data processing circuitry (designated also as processing circuitry) can comprise, for example, one or more processors operatively connected to computer memory, loaded with executable instructions for executing operations. The data processing circuitry encompasses a single processor or multiple processors, which may be located in the same geographical zone, or may, at least partially, be located in different zones, and may be able to communicate together.

The one or more processors referred to herein can represent one or more general-purpose processing devices such as a microprocessor, a central processing unit, or the like. More particularly, a given processor may be one of a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application-specific integrated circuit (ASIC), a field programmable gate array (FPGA), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

The term “specimen” used in this specification should be expansively construed to cover any kind of physical objects or substrates including wafers, masks, reticles, and other structures, combinations and/or parts thereof used for manufacturing semiconductor integrated circuits, magnetic heads, flat panel displays, and other semiconductor-fabricated articles. A specimen is also referred to herein as a semiconductor specimen, and can be produced by manufacturing equipment executing corresponding manufacturing processes.

The term “examination” used in this specification should be expansively construed to cover any kind of operations related to defect detection, defect review, and/or defect classification of various types, segmentation, and/or metrology operations during and/or after the specimen fabrication process. Examination is provided by using non-destructive examination tools during or after manufacture of the specimen to be examined. By way of non-limiting example, the examination process can include runtime scanning (in a single or in multiple scans), imaging, sampling, detecting, reviewing, measuring, classifying, and/or other operations provided with regard to the specimen or parts thereof, using the same or different inspection tools. Likewise, examination can be provided prior to manufacture of the specimen to be examined, and can include, for example, generating an examination recipe(s) and/or other setup operations. It is noted that, unless specifically stated otherwise, the term “examination”, or its derivatives used in this specification, is not limited with respect to resolution or size of an inspection area. A variety of non-destructive examination tools includes, by way of non-limiting example, scanning electron microscopes (SEM), atomic force microscopes (AFM), optical inspection tools, etc.

The term “metrology operation” used in this specification should be expansively construed to cover any metrology operation procedure used to extract metrology information relating to one or more structural elements on a semiconductor specimen. In some embodiments, the metrology operations can include measurement operations, such as, e.g., critical dimension (CD) measurements performed with respect to certain structural elements on the specimen, including but not limited to the following: dimensions (e.g., line widths, line spacing, contact diameters, size of the element, edge roughness, gray level statistics, etc.), shapes of elements, distances within or between elements, related angles, overlay information associated with elements corresponding to different design levels, etc. Measurement results, such as measured images, are analyzed, for example, by employing image-processing techniques. Note that, unless specifically stated otherwise, the term “metrology”, or derivatives thereof used in this specification, is not limited with respect to measurement technology, measurement resolution, or size of inspection area.

The term “defect” used in this specification should be expansively construed to cover any kind of abnormality or undesirable feature/functionality formed on a specimen. In some cases, a defect may be a defect of interest (DOI) which is a real defect that has certain effects on the functionality of the fabricated device, thus is in the customer's interest to be detected. For instance, any “killer” defects that may cause yield loss can be indicated as a DOI. In some other cases, a defect may be a nuisance (also referred to as a “false alarm” defect) which can be disregarded because it has no effect on the functionality of the completed device and does not impact yield.

The term “defect candidate” used in this specification should be expansively construed to cover a suspected defect location on the specimen which is detected to have a relatively high probability of being a defect of interest (DOI). Therefore, a DOI candidate, upon being reviewed/tested, may actually be a DOI, or, in some other cases, it may be nuisances, or random noise that can be caused by different variations (e.g., process variation, color variation, mechanical and electrical variations, etc.) during inspection.

The term “design data” used in the specification should be expansively construed to cover any data indicative of hierarchical physical design (layout) of a specimen. Design data can be provided by a respective designer and/or can be derived from the physical design (e.g., through complex simulation, simple geometric and Boolean operations, etc.). Design data can be provided in different formats as, by way of non-limiting examples, GDSII format, OASIS format, etc. Design data can be presented in vector format, grayscale intensity image format, or otherwise.

The term “image(s)” or “image data” used in the specification should be expansively construed to cover any original images/frames of the specimen captured by an examination tool during the fabrication process, derivatives of the captured images/frames obtained by various pre-processing stages, and/or computer-generated synthetic images (in some cases based on design data). Depending on the specific way of scanning (e.g., one-dimensional scan such as line scanning, two-dimensional scan in both x and y directions, or dot scanning at specific spots, etc.), image data can be represented in different formats, such as, e.g., as a gray level profile, a two-dimensional image, or discrete pixels, etc. It is to be noted that in some cases the image data referred to herein can include, in addition to images (e.g., captured images, processed images, etc.), numeric data associated with the images (e.g., metadata, hand-crafted attributes, etc.). It is further noted that images or image data can include data related to a processing step/layer of interest, or a plurality of processing steps/layers of a specimen.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the present detailed description, numerous specific details are set forth in order to provide a thorough understanding of the methods and apparatus.

It will also be understood that the system according to the present disclosure may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as hereinbefore described without departing from its scope, defined in and by the appended claims.

1. A computerized system for automatic zone generation for overlay metrology on a semiconductor specimen, the system comprising a processing circuitry configured to:
obtain design data and image data of the semiconductor specimen comprising at least a first layer and a second layer;
provide a plurality of first zone options for the first layer and a plurality of second zone options for the second layer, comprising, for each of the first layer and the second layer:
i) identify, based on the design data, a plurality of candidate zone options each representing an initial measurement region characterized by one or more initial values of one or more zone parameters; and
ii) execute a zone optimization process for each candidate zone option using the image data, to determine a zone option characterized by one or more optimized values for the one or more zone parameters, the zone option representing an optimal configuration that, when applied to the image data, yields optimal measurement performance for the candidate zone option;
compute an overlay measurement between the first layer and the second layer for different combinations of the first zone options and the second zone options; and
select a combination of a first zone option and a second zone option which provides optimal overall performance for the overlay measurement.

2. The computerized system according to claim 1, wherein the processing circuitry is configured to identify the plurality of candidate zone options for each designated layer of the first layer and the second layer by:
separating one or more target features on the designated layer from one or more remaining features within the designated layer and/or within one or more remaining layers of the design data; and
defining the plurality of candidate zone options to enclose at least part of the one or more target features, such that each candidate zone option comprises one or more symmetric candidate zones, and does not overlap interfering features from the designated layer and/or the one or more remaining layers.

3. The computerized system according to claim 1, wherein the one or more zone parameters comprise one or more of a zone shift parameter, a zone pitch parameter, and a zone size parameter.

4. The computerized system according to claim 1, wherein the zone optimization process comprises:
for each candidate zone option, varying values of the one or more zone parameters to generate a permutation array of modified zone options;
evaluating the modified zone options in the permutation array using the image data to determine measurement performance; and
selecting, from the permutation array, a modified zone option that yields optimal measurement performance to be the optimal configuration of the candidate zone option.

5. The computerized system according to claim 4, wherein the evaluating of the modified zone options comprises:
for each modified zone option in the permutation array, calculating one or more measurement metrics based on the image data to which the modified zone option is applied;
calculating a robustness score for each of the one or more measurement metrics; and
selecting the modified zone option from the permutation array to be the optimal configuration, based on at least some of the one or more measurement metrics and the robustness score thereof for each modified zone option.

6. The computerized system according to claim 5, wherein the one or more measurement metrics comprise at least one of a symmetry center metric or an image symmetry metric.

7. The computerized system according to claim 6, wherein each candidate zone option comprises at least two pairs of symmetric candidate zones, and the symmetry center metric and image symmetry metric, and the robustness score thereof, are calculated for each pair of the two pairs of symmetric candidate zones;
wherein the optimization process further comprises calculating a symmetry center difference metric by comparing the symmetry center metrics of the two pairs of symmetric candidate zones, and the optimal configuration is selected further based on the symmetry center difference metric.

8. The computerized system according to claim 5, wherein the robustness score is calculated based on a standard deviation of each measurement metric over a set of neighboring modified zone options of a given modified zone option within the permutation array.

9. The computerized system according to claim 5, wherein the robustness score quantifies sensitivity of the one or more measurement metrics of a given modified zone option to variations across a set of neighboring modified zone options.

10. The computerized system according to claim 1, wherein the selected combination is used to measure overlay for one or more runtime specimens sharing the same design data as the semiconductor specimen.

11. The computerized system according to claim 1, wherein the optimal overall performance for the overlay measurement is in terms of precision and correlation.

12. A computer-implemented method of automatic zone generation for overlay metrology on a semiconductor specimen, the method comprising:
obtaining design data of the semiconductor specimen comprising at least a first layer and a second layer, and acquiring image data of the specimen;
providing a plurality of first zone options for the first layer and a plurality of second zone options for the second layer, comprising, for each of the first layer and the second layer:
i) identifying, based on the design data, a plurality of candidate zone options each representing an initial measurement region characterized by one or more initial values of one or more zone parameters; and
ii) executing a zone optimization process for each candidate zone option using the image data, to determine a zone option characterized by one or more optimized values for the one or more zone parameters, the zone option representing an optimal configuration that, when applied to the image data, yields optimal measurement performance for the candidate zone option;
computing an overlay measurement between the first layer and the second layer for different combinations of the first zone options and the second zone options; and
selecting a combination of a first zone option and a second zone option which provides optimal overall performance for the overlay measurement.

13. The method according to claim 12, wherein the plurality of candidate zone options are identified for each designated layer of the first layer and the second layer by:
separating one or more target features on the designated layer from one or more remaining features in the designated layer and/or in one or more remaining layers of the design data; and
defining the plurality of candidate zone options to enclose at least part of the one or more target features, such that each candidate zone option comprises one or more symmetric candidate zones, and does not overlap interfering features from the designated layer and/or the one or more remaining layers.

14. The method according to claim 12, wherein the zone optimization process comprises:
for each candidate zone option, varying values of the one or more zone parameters to generate a permutation array of modified zone options;
evaluating the modified zone options in the permutation array using the image data to determine measurement performance; and
selecting, from the permutation array, a modified zone option that yields optimal measurement performance to be the optimal configuration of the candidate zone option.

15. The method according to claim 14, wherein the evaluating comprises:
for each modified zone option in the permutation array, calculating one or more measurement metrics based on the image data to which the modified zone option is applied;
calculating a robustness score for each of the one or more measurement metrics; and
selecting the modified zone option from the permutation array to be the optimal configuration, based on at least some of the one or more measurement metrics and the robustness score thereof for each modified zone option.

16. The method according to claim 15, wherein the one or more measurement metrics comprise at least one of a symmetry center metric or an image symmetry metric.

17. The method according to claim 16, wherein each candidate zone option comprises at least two pairs of symmetric candidate zones, and the symmetry center metric and image symmetry metric, and the robustness score thereof, are calculated for each pair of the two pairs of symmetric candidate zones;
wherein the optimization process further comprises calculating a symmetry center difference metric by comparing the symmetry center metrics of the two pairs of symmetric candidate zones, and the optimal configuration is selected further based on the symmetry center difference metric.

18. The method according to claim 15, wherein the robustness score is calculated based on a standard deviation of each measurement metric over a set of neighboring modified zone options of a given modified zone option within the permutation array.

19. The method according to claim 12, wherein the selected combination is used to measure overlay for one or more runtime specimens sharing the same design data as the semiconductor specimen.

20. A non-transitory computer readable storage medium tangibly embodying a program of instructions that, when executed by a computer, cause the computer to perform a method of automatic zone generation for overlay metrology on a semiconductor specimen, the method comprising:
obtaining design data of the semiconductor specimen comprising at least a first layer and a second layer, and acquiring image data of the specimen;
providing a plurality of first zone options for the first layer and a plurality of second zone options for the second layer, comprising, for each of the first layer and the second layer:
i) identifying, based on the design data, a plurality of candidate zone options, each representing an initial measurement region characterized by one or more initial values of one or more zone parameters; and
ii) executing a zone optimization process for each candidate zone option using the image data, to determine a zone option characterized by one or more optimized values for the one or more zone parameters, the zone option representing an optimal configuration that, when applied to the image data, yields optimal measurement performance for the candidate zone option;
computing an overlay measurement between the first layer and the second layer for different combinations of the first zone options and the second zone options; and
selecting a combination of a first zone option and a second zone option which provides optimal overall performance for the overlay measurement.
